(19) United States
(12) Patent Application Publication
(10) Pub. No.: US 2015/0208423 A1
(43) Pub. Date: Jul. 23, 2015

(54) METHOD FOR SETTING A FIRST NUMBER OF SUBFRAMES WITH REDUCED POWER FOR DOWNLINK TRANSMISSION OF A FIRST CELL

(71) Applicant: Jawad Manssour, Seoul (KR)

(72) Inventor: Jawad Manssour, Seoul (KR)

(73) Assignee: Telefonaktiebolaget L M Ericsson (publ), Stockholm (SE)

(21) Appl. No.: 14/408,500

(22) PCT Filed: Jun. 21, 2012
(86) PCT No.: PCT/SE2012/050694

§ 371 Date: Dec. 16, 2014

(51) Int. Cl. H04W 72/08

(52) U.S. Cl. CPC H04W 72/082

(57) ABSTRACT

A method and a network node for setting a first number of subframes for downlink transmission of a first cell are disclosed. The downlink transmission in each subframe of the first number of subframes has a reduced power. The network node obtains information about at least one first user equipment's capability of mitigating interference, the interference being caused by the downlink transmission. Next, the network node sets the first number of subframes based on the information about the at least one first user equipment's capability of mitigating the interference.

### TECHNICAL FIELD

Embodiments herein relate to the field of cellular radio communication. A method and a network node for setting a first number of subframes for downlink transmission of a first cell are disclosed.

### BACKGROUND

A cellular radio system is typically operated on a specific, limited radio spectrum due to for example cost of licenses for radio spectrum and other reasons. Since the radio spectrum, or bandwidth, is limited, it is highly desirable to utilize the available radio spectrum as efficiently as possible. Therefore, a so called reuse-1 is utilized in many modern cellular systems, such as Long Term Evolution (LTE) and WiMAX. Reuse-1 refers to that the available licensed radio spectrum is reused in all cells in the cellular system. When the entire licensed radio spectrum is reused in all cells, the bandwidth for each cell is greater compared to when different portions of the licensed radio spectrum is used in different cells. Hence, by utilizing reuse-1, the system's capacity may be increased.

Although, reuse-1 would result in high peak throughput for user equipments close to a base station and high cell capacity in general, it may also lead to a high interference towards user equipments at the cell edge. Interference towards these user equipment becomes further accentuated in heterogeneous deployments commonly referred to as HetNets. In a HetNet different cells have different output power, which leads to a discrepancy between uplink and downlink coverage.

The discrepancy between uplink and downlink coverage, i.e. an uplink/downlink coverage imbalance, will for example result in a problem relating to cell selection.

A known HetNet system, or HetNet deployment, comprises a macro cell and a pico cell, in which a user equipment is located. In certain areas around the pico cell, channel quality for an uplink channel towards the pico cell is better than channel quality for an uplink channel towards the macro cell due to that the user equipment is located closer, in distance, to the pico cell. However, at the same time, channel quality for a downlink channel from the macro cell is better than channel quality for a downlink channel from the pico cell due to that the macro cell is transmitting with higher power as compared to transmit power of the pico cell. According commonly applied principles for cell selection, the user equipment would be connected to the macro cell. Therefore, in order to offload the macro cell, some user equipments at the macro cell may be transferred to the pico cell. The transfer of user equipments is achieved by a so called cell-selection offset at the pico cell. This means that a certain cell-selection offset is utilized for the pico cell on top of the reference signal received power (RSRP) in order to allow the pico cell to pick up more user equipments from the macro cell. Thus, user equipments, which would according to the commonly applied principles for cell selection be connected to the macro cell, will now connect to the pico cell. The certain cell-selection offset extends the coverage area of the pico cell. This is commonly known as cell-range expansion (CRE).

In the context of HetNet, and within the Third Generation Partnership Projectc (3GPP) community, time-domain Inter-Cell Interference Cancellation (ICIC), also known as eICIC, is proposed in order to solve problems relating to high interference especially in downlink from the macro cell to the user equipments at the cell-edge, such as user equipments in the cell-range expansion (CRE) area and connected to the pico cell. According to eICIC, some subframes are reserved. In these reserved subframes, the macro cell refrains from transmitting anything except of the cell-specific reference signals (CRS). The reserved frames are referred to as Almost Blank SubFrames (ABS). During an ABS subframe, the pico cell is expected to schedule its user equipments, located in the CRE area, as they would not see any interference from the macro cell. There exists various so called ABS patterns, with different amount of ABS and/or different positions for the ABS.

Although the utilization of ABS would reduce the interference in the pico cell during some subframes, it would also result in unexploited resources in the macro cell and can potentially decrease the spectral efficiency.

Therefore, Reduced Power SubFrames (RPSF) have been introduced. Instead of blanking, i.e. muting, as with ABS, a transmit power, which is lower than transmit power normally applied, is used for the RPSF. Similarly to ABS pattern, there exists various RPSF patterns.

However, the reduced power subframes may also result in reduced spectral efficiency and may affect performance of the system due to the need for a Radio Resource Control (RRC) reconfiguration for the majority of transmissions modes (TM), except for TM7/8/9. Furthermore, peak downlink throughput may be reduced as a result of utilizing either ABS or RPSF.

Thus, ABS and RPSF may limit the system's spectral efficiency and even capacity due to constraining the amount of resources (time and power) that may be utilized in the macro cell.

### SUMMARY

An object is to improve performance for network nodes in a radio communication system, such as the initially mentioned HetNet deployment.

According to an aspect, the object is achieved by a method in a network node for setting a first number of subframes for downlink transmission of a first cell. The downlink transmission in each subframe of the first number of subframes has a reduced power. The network node obtains information about at least one first user equipment's capability of mitigating interference, the interference being caused by the downlink transmission. Next, the network node sets the first number of subframes based on the information about the at least one first user equipment's capability of mitigating the interference.

According to another aspect, the object is achieved by a network node configured to set a first number of subframes for downlink transmission of a first cell. The downlink transmission in each subframe of the first number of subframes has a reduced power. The network node comprises a processing circuit configured to: obtain information about at least one first user equipment's capability of mitigating interference, the interference being caused by the downlink transmission. Furthermore, the processing circuit is configured to set the first number of subframes based on the information about the at least one first user equipment's capability of mitigating the interference.

According to embodiments herein, the information about at least one first user equipment's capability of mitigating interference is used when the first number of subframes is set. The information may be indicative of whether the at least one first user equipment comprises an advanced receiver, such as an Interference Cancelling (IC) receiver, that is capable of mitigating interference. The first number of subframes may be represented by an ABS pattern, a RPSF pattern or the like, which restricts transmission of the first cell, such as a macro cell.

For example, the higher number of user equipments with advanced receivers capable of mitigating interference, the less restricted transmission of the network node, such as a macro cell, may be required.

An advantage is that the number of subframes, in which time and/or power constraints are put on the macro cell, is reduced. This results in an increase in the system's spectral efficiency and capacity, in addition to a less constraining scheduling and power control implementation.

Furthermore, higher downlink peak throughput may be achieved compared to a system utilizing ABS/RPSF which are set without exploiting the information about user equipment's capability of mitigating interference (the receiver type of active user equipments) in the cells, such as pico or macro cells.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 shows a schematic overview of an exemplifying radio communication system in which exemplifying methods according embodiments herein may be implemented,

FIG. 2 shows a schematic, combined signaling scheme and flowchart of the exemplifying methods performed in the radio communication system according to FIG. 1,

FIG. 3 shows a schematic flowchart of an exemplifying method according to embodiments herein,

FIG. 4 shows another schematic flowchart of another exemplifying method according to embodiments herein,

FIGS. 5a and 5b show exemplifying ABS patterns,

FIG. 6 shows a schematic flowchart of the methods of FIG. 2 when implemented in the network node, and

FIG. 7 shows a schematic block diagram of an exemplifying network node configured to perform the methods illustrated in FIG. 2, 3, 4 and/or 6.

### DETAILED DESCRIPTION

Throughout the following description similar reference numerals have been used to denote similar elements, network nodes, parts, items or features, when applicable. In the Figures, features that appear in some embodiments are indicated by dashed lines.

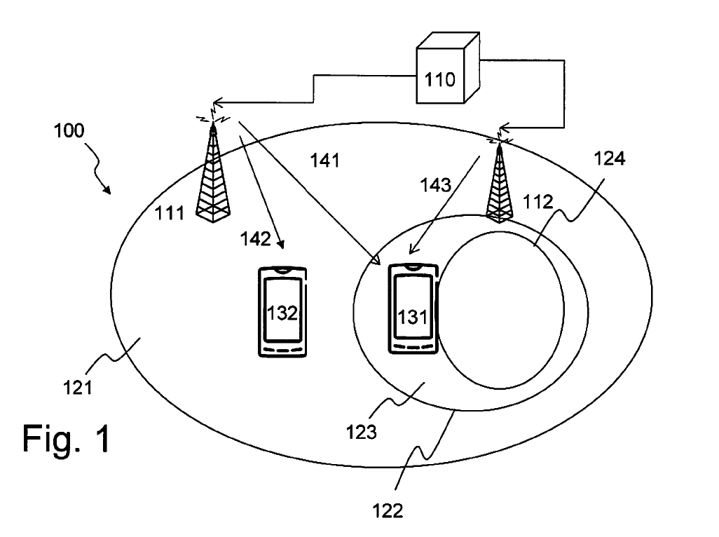

FIG. 1 depicts an exemplifying radio communications system 100 in which embodiments herein may be implemented. In this example, the radio communications system 100 is an Long Term Evolution (LTE) system. In other examples, the radio communication system may be any 3GPP cellular communication system, such as a Wideband Code Division Multiple Access (WCDMA) network, a Global System for Mobile communication (GSM network) or the like.

The radio communication system 100 comprises a first radio network node 111 and a second radio network node 112. As used herein, the term “radio network node” may refer to an evolved Node B (eNB), a control node controlling one or more Remote Radio Units (RRUs), a radio base station, an access point or the like.

The first radio network node 111 may operate a first cell 121, such as a macro cell, and the second radio network node 112 may operate a second cell 122, such as a pico or micro cell. More generally, the first and second cells 121, 122 may be comprised in the radio communication system 100. In some examples, the first and second cells 121, 122 are comprised in a heterogeneous network comprised in the radio communication system 100. The second cell 122 may have a cell range expansion area 123 and an area 124 without cell range expansion. The second cell 122 may be with or without cell range expansion. In cases with cell range expansion, interference from the first cell 121 may be higher for user equipments at the cell edge than for user equipments at the cell edge without cell range expansion.

Furthermore, the radio communication system 100 comprises a central network node 110 for controlling for example the first and second radio network nodes 111, 112.

Throughout the present disclosure, the term “network node” is used to refer to at least one of the first and second radio network nodes 111, 112 and the central network node 110. Thus, the network node may be the central node 110, the first radio network node 111 or the second radio network node 112.

Furthermore, a first user equipment 131 is located in the second cell 122. Expressed differently, the first user equipment 131 may be associated with the second cell 122. The first user equipment 131 may receive 141 interference from the first radio network node 111. As used herein, the term “user equipment” may refer to a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be any kind of weather sensor, such as wind, temperature, air pressure, humidity etc. As further examples, the sensor may be a light sensor, an electronic switch, a microphone, a loudspeaker, a camera sensor etc.

Typically, the interference occurs when the first radio network node 111 sends 142 a downlink transmission, i.e. a downlink radio transmission, to a second user equipment 132, located in the first cell 121. In particular, the interference is expected to be severe when the first user equipment 131 is in a cell range expansion area of the second cell 122. Therefore, in order to reduce the interference from the first radio network node 111 towards the first user equipment 131, the first radio network node 111 may be restricted in terms of subframes or transmit power. As discussed in the background section, for example ABS or RPSF may be used to limit interference towards the first user equipment 131. Herein, a term “decreased power subframes” may be used to refer to ABS, RPSF or any other subframes which are restricted in order to reduce interference from the first radio network node 111 towards the first user equipment 131.

For example, the first radio network node 111 may not be allowed to transmit in certain subframes, herein referred to as a first number of subframes. The first number of subframes may be represented by a decreased power subframe pattern, such as an ABS pattern, an RPSF pattern or other similar pattern. Since the transmit power of the first radio network node 111 is reduced, or even zero, for the first number of subframes, it is beneficial for the second radio network node 112 to send 143 downlink transmission to the first user equipment 131 in these subframes, which may be referred to as subframes with decreased power. However, as noted earlier, some reference signaling or the like may still be allowed in the first number of subframes. More generally, the ABS pattern, the RPSF pattern or the like may be referred to as a transmission pattern for interference mitigation.

As mentioned, the information about the first user equipment's capability of mitigating interference may be Interference Cancellation (IC) receiver capability of user equipments in the second cell 122.

By exploiting the above information, the system will be able to check if it is possible to for example decrease the density of the ABS or RPSF by virtue of having user equipments with IC capable receivers in the CRE of the pico cell. That is because such user equipments may not need ABS or RPSF in order to have a good performance as their receivers are able to tolerate high interference. The higher the number of user equipments with such receivers, the lower is the required density of the ABS/RPSF or the like.

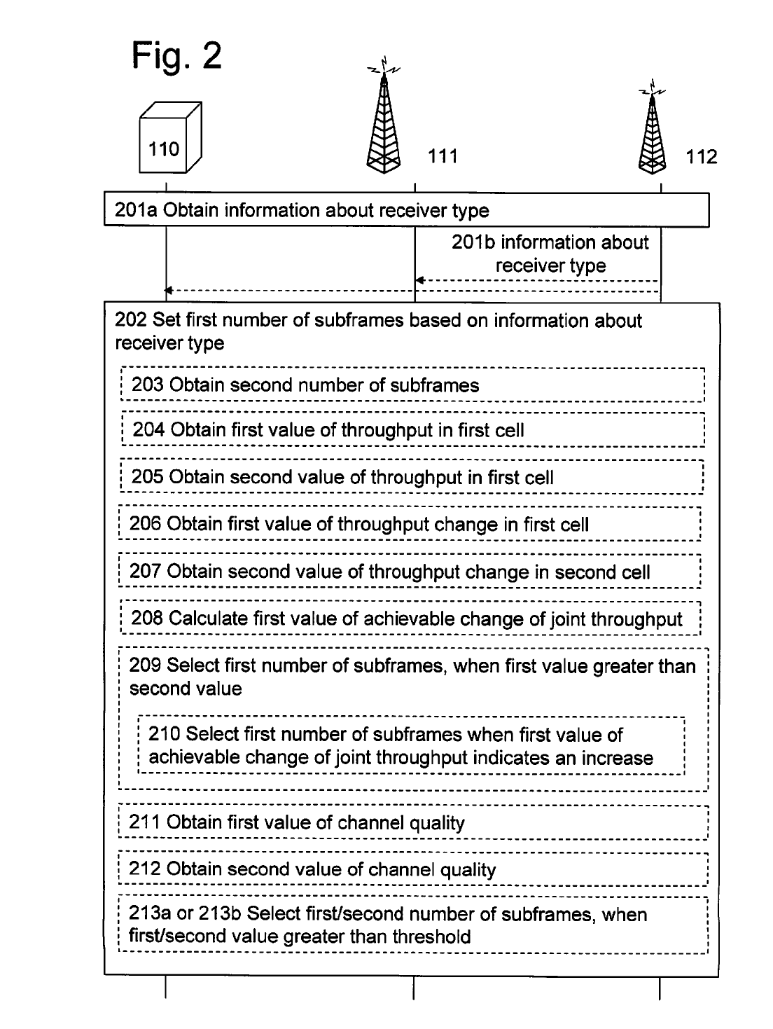

FIG. 2 illustrates an exemplifying method for setting a first number of subframes for downlink transmission of the first cell 121 when implemented in the radio communication system 100 of FIG. 1. Thus, the network node 110, 111, 112 performs a method for setting a first number of subframes for downlink transmission of a first cell 121. The downlink transmission in each subframe of the first number of subframes has a reduced power. Thanks to the reduced power, interference towards the at least one first user equipment 131 of the second cell 122 is reduced. The reduced power is obtained by adjusting threshold values in a power control loop. Hence, the reduced power refers to an overall restriction in transmission power of the first cell 121. Expressed somewhat differently, reduced power refers to a reduction in transmission power for transmissions in the first cell 121 compared to a full available power. As mentioned, the first number of subframes may include ABS, RPSF or the like. Throughout the present disclosure, the first number of subframes refers to a first number of subframes with reduced power.

The at least one first user equipment 131 may be in a cell range expansion area of the second cell 122.

The following actions may be performed in any suitable order.

### Action 201a and 201b

In order for the network node 110, 111, 112 to be able to use the information about the at least one first user equipment's 131 capability of mitigating interference, the network node 110, 111, 112 obtains information about at least one first user equipment's 131 capability of mitigating interference, the interference being caused by the downlink transmission.

As a first example, when the second radio network node 112 operates the second cell 122, the network node 110, 111, 112 may receive the information from the second radio network node 112. In this example, the network node 110, 111, 112 may be the central node 110 or the first radio network node 111. This is shown as action 201b in FIG. 2.

As a second example, the network node 110, 111, 112 may estimate the information about at least one first user equipment's 131 capability of mitigating interference, or may receive, from the at least one first user equipment 131, the information about at least one first user equipment's 131 capability of mitigating interference.

### Action 202

When the network node 110, 111, 112 has obtained, in action 201a, 201 b, the information about the at least one first user equipment's 131 capability of mitigating interference, the network node 110, 111, 112 sets the first number of subframes based on the information about the at least one first user equipment's 131 capability of mitigating the interference.

In this manner, the information is used for efficiently distributing radio resources between the first and second cells 121, 122.

When the information indicates that the at least one first user equipment 131 is capable of mitigating the interference, it implies that the at least one first user equipment 131 is able to handle the interference well as compared to user equipments without capability of mitigating the interference. Therefore, fewer subframes for the first radio network node 111 may be required to be restricted as compared to when user equipments associated with the second cell 122 are not capable of mitigating the interference. As a result, there will be more availability of radio resources, such as subframes, resource blocks, maximum allowed transmit power or the like, for scheduling in the first radio network node 111 when the first number of subframes, such as an ABS pattern, is set based on the information about the at least one first user equipment's capability of mitigating the interference.

Thus, throughput for the first radio network node 111 is increased, if there is enough data to send, to the second user equipment 132, as compared to when setting the first number of subframes without considering the information.

In some scenarios, ABS/RPSF may be completely turned off if the at least one first user equipment 131 has an IC capable receiver. Therefore, the network node 110, 111, 112 may set the first number of subframes to zero.

The setting of the first number of subframes may further be based on one or more of:

a number of user equipments, in the second cell 122, with capability of mitigating the interference;

a bit rate relating to the at least one first user equipment 131 in a cell range expansion area of the second cell 122; and

a load relating to user equipments, in the second cell 122, with capability of mitigating the interference.

The bit rate may be determined based on amount of user data in downlink data buffers for the second cell.

The load may be measured in terms of transmission power in the second cell 122.

As a further example, channel quality of the at least one first user equipment 131 and/or channel quality of the second user equipment 132 may be taken into account when setting the first number of subframes. Channel quality may be measured in terms of a Signal-to-Interference-Ratio (SIR), a Signal-to-Noise-Ratio (SNR) or a Signal-to-Interference-and-Noise-Ratio (SINR).

### Action 203

The network node 110, 111, 112 may obtain a second number of subframes for downlink transmission of the first cell 121. As an example, the second number of subframes may relate to an ABS pattern already applied in the first cell 121. Then, it is possible to determine whether or not to change the ABS pattern.

The second number of subframes may be different from the first number of subframes. In this manner, the network node 110, 111, 112 may check which of the first and second number of subframes gives a better result for example in terms of throughput. It shall be understood that the first or second number of subframes may also refer to no subframes at all. That is to say, the first or second number is zero, which means that no decreased power subframes are to be used. Hence, the network node 110, 111, 112 may also check whether or not to apply any decreased subframe pattern at all.

### Action 204

The network node 110, 111, 112 obtains a first value of throughput, achievable in the first cell 121 for the first number of subframes. The first value of throughput may be used in action 206 and/or 209.

When the network node is the first radio network node 111, the first value of throughput may be estimated by the first radio network node 111 based on information about channel quality and amount of data in downlink data buffers.

When the network node is the central network node 110, the first value of throughput may be received from the first radio network node 111 or the central network node 110 may receive, from the first radio network node 111, information for estimating the first value of throughput.

### Action 205

The network node 110, 111, 112 may obtain a second value of throughput, achievable in the first cell 121 for the second number of subframes. The second value of throughput may be used in action 206 and/or 209.

When the network node is the first radio network node 111, the second value of throughput may be estimated by the first radio network node 111 based on information about channel quality and amount of data in downlink data buffers.

When the network node is the central network node 110 or the second radio network node 112, the second value of throughput may be received from the first radio network node 111 or the central network node 110 may receive, from the first radio network node 111, information for estimating the second value of throughput.

### Action 206

The network node 110, 111, 112 may obtain, or calculate, a first value of throughput change, achievable in the first cell 121, based on a first difference between the first value of throughput and the second value of throughput. The first value of throughput change may be used in 208.

### Action 207

The network node 110, 111, 112 may obtain a second value of throughput change, achievable in the second cell 122, based on a second difference between a third value of throughput, achievable in the second cell 122 for the first number of subframes, and a fourth value of throughput, achievable in the second cell 122 for the second number of subframes. The second value of throughput change may be used in action 208.

### Action 208

The network node 110, 111, 112 may calculate a first value indicating achievable change of joint throughput in the first and second cells 121, 122. The first value indicating achievable change of joint throughput is calculated as a third difference between the first value of throughput change and the second value of throughput change. The first value indicating achievable change of joint throughput may be used in action 209 in order to determine whether or not the setting of the first number of subframes would be beneficial to the second user equipment 132 in the first cell 121.

### Action 209

The network node 110, 111, 112 may select the first number of subframes, when the first value of throughput is greater than the second value of throughput. This implies that improved throughput in the first cell 121 is, in this case, enough to justify use of the first number of subframes. Actions 204 and 205 may be performed in any order prior to action 209.

In conjunction herewith, the following embodiments are presented. In these embodiments, the first number of subframes is greater than the second number of subframes. The second number of subframes may be applied to the first cell 121 or may indicate that no subframes with reduces power are applied to the first cell 121. In the description of these embodiments losses and/or gains may be measured in terms of throughput, channel quality or the like. Gains and/or losses in terms of throughput are described in for example action 205-208. Gains and/or losses in terms of channel quality are described in for example action 211-212.

In a first embodiment, the first number of subframes may be selected when the losses in the first cell 121 is less than a first threshold.

In a second embodiment, the second number of subframes may be selected when the gains in the first cell 121 are greater than a second threshold.

In a third embodiment, the second number of subframes may be selected when the losses in the second cell 122 are less than a third threshold.

In a fourth embodiment, the first number of subframes may be selected when the gains in the second cell 122 are greater than a fourth threshold. According to the third and fourth embodiment, it is enough that conditions, such as throughput, performance or the like, in the second cell 122 are improved, e.g. increased, in order to justify use of the first or second number of subframes.

The first, second, third and fourth threshold are set to avoid a change of the first number of subframes when the gains and/or losses are only slightly better than for an already applied number of subframes. As a result, for example an ABS pattern is not replaced when only minor improvements may be achieved. Furthermore, when comparing two ABS patterns some margin may need to be applied in order to avoid for example toggling between patterns which would cause undesired signaling in cases where throughput (or performance) difference is relatively small.

### Action 210

In this action 209, is further elaborated.

The network node 110, 111, 112 may select the first number of subframes, when the first value indicating achievable change of joint throughput indicates an increase of the joint throughput in the first and second cells 121, 122. Normally, actions 206-208 may be performed in any order prior to action 210.

In this manner, overall throughput, i.e. throughput in first and second cell considered together, is increased.

### Action 211

The network node 110, 111, 112 may obtain a first value of channel quality for the at least one first user equipment 131 while taking the information about the at least one first user equipment's 131 capability of mitigating the interference and the first number of subframes into account. The first value of channel quality may be used in action 213a.

### Action 212

The network node 110, 111, 112 may obtain a second value of channel quality for the at least one first user equipment 131 while taking the information about the at least one first user equipment's 131 capability of mitigating the interference and the second number of subframes into account. The second value of channel quality may be used in action 213b.

In further examples, estimates of channel quality for the second user equipment 132 in the first cell 121 may be obtained for the first and second number of subframes.

One of actions 213a and 213b below may be performed.

### Action 213a

The network node 110, 111, 112 may select the first number of subframes, when the first value of channel quality is greater than a threshold for required channel quality at the at least one first user equipment 131. The threshold for required channel quality may be based on Quality of Service, amount of data in downlink buffer and the like.

### Action 213b

The network node 110, 111, 112 may select the second number of subframes, when the second value of channel quality is greater than the threshold for required channel quality at the at least one first user equipment 131.

As is explicitly described with reference to actions 204 and 205, the term “obtain” may be exemplified by “receive”, “estimate” or “receive and estimate/calculate” as applicable depending on whether the network node 110, 111, 112 is the central node 110, the first or second radio network node 111, 112 and for which of the first and second cells 121, 122 a value or the like is obtained.

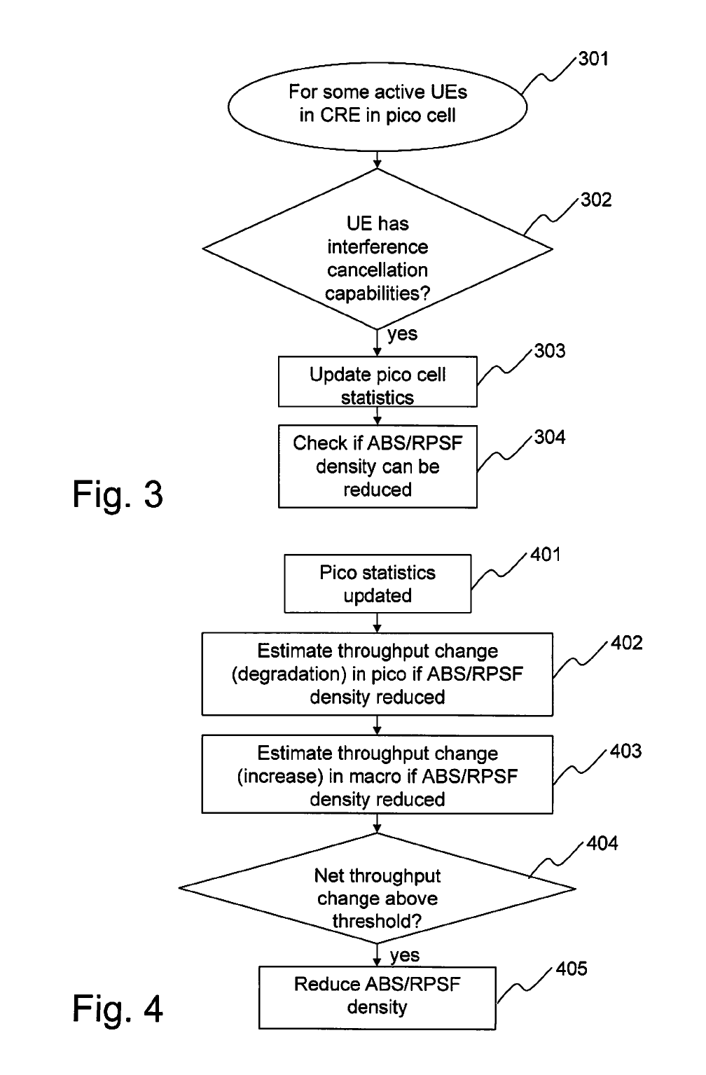

FIG. 3 shows an exemplifying flowchart of an exemplifying method in the network node 110, 111, 112. The following actions may be performed in any suitable order.

### Action 301

For some, or even all, active user equipments (UEs) in the second cell 122, action 302 is performed. The active user equipments may be in a cell range expansion area of the second cell. Active UEs refers to user equipments, whose downlink user data buffer is non-empty. This means that these UEs have user data to be received in downlink.

### Action 302

The network node 110, 111, 112 may check which user equipments among the active user equipments have IC capabilities (capability of mitigating interference). This action is similar to action 201a and 201b.

### Action 304

The network node 110, 111, 112 may update statistics about the second cell 122. The statistics may relate to number of user equipments with IC capabilities, amount of user data in downlink buffers for these user equipments, average channel quality for these user equipments and the like.

### Action 304

Based on the updated statistics, the network node 110, 111, 112 checks if it is possible to reduce the number of ABS/RPSF for the first cell 121. This action relates to action 202 to 2012 and in particular to action 213a and 213b.

FIG. 4 shows a schematic flowchart of an exemplifying method in the network node. The flowchart illustrates an example of renegotiating the ABSIRPSF density. The following actions may be performed in any suitable order, preferably after the actions of FIG. 3.

### Action 401

The statistics about the second cell are updated as described in FIG. 3.

### Action 402

The second radio network node 112 may estimate throughput change in the second cell if the ABS/RPSF density is reduced. For example, throughput for a first and a second number of subframes may be estimated. See for example action 207.

### Action 403

The first radio network node 111 may also estimate throughput change in the first cell 121 if the ABSIRPSF density is reduced. See for example action 206 (and 204 and 205).

### Action 404

The net total throughput change is then calculated, by the network node 110, 111, 112 (either at pico, at macro, or at a third node, such as the central node 110). See for example action 208.

### Action 405

If the net throughput change is above a certain threshold, then the ABSIRPSF density may be reduced. If not, the pico cell would need more user equipments in CRE area with IC capabilities before the system is able to further reduce the ABS/RPSF density. See for example action 210.

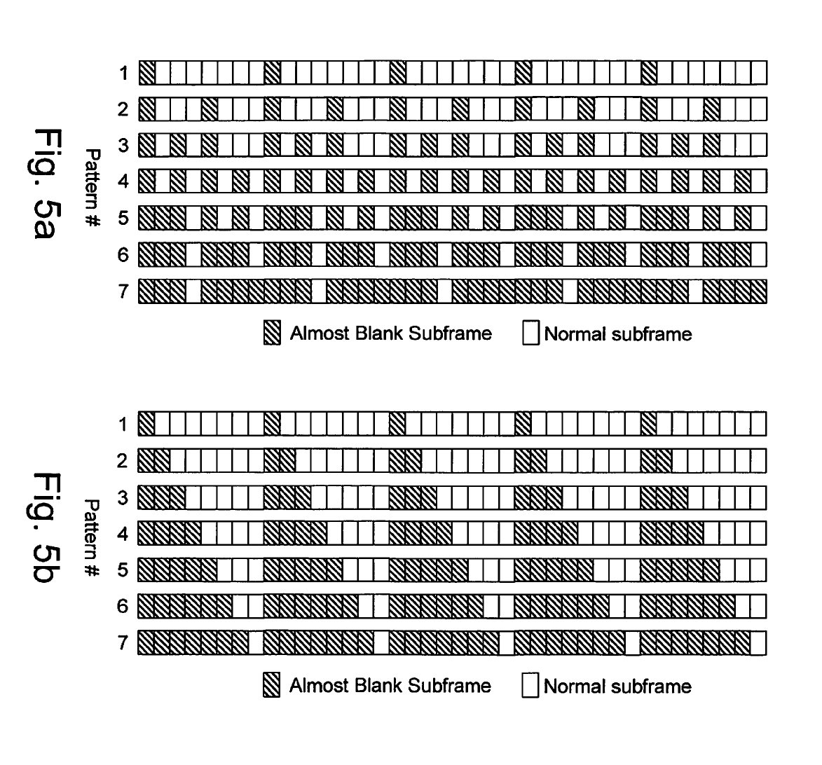

FIG. 5a and FIG. 5b show exemplifying ABS patterns, each pattern having a different ABS density, i.e. the amount of ABS vs. non-ABS subframes. In the FIGS. 40 subframes of each pattern are shown. Each subframe has a duration of 1 ms.

In FIG. 5a, seven different patterns are shown. The striped squares indicate the position of ABS subframes. Pattern no. 1-7 of FIG. 5a have a ABS density of 12,5%, 25%, 37,5%, 50%, 62,5%, 75% and 87,5%, respectively.

Similarly, in FIG. 5b, seven exemplifying ABS patterns are shown. Again, pattern no. 1-7 of FIG. 5b have a ABS density of 12,5%, 25%, 37,5%, 50%, 62,5%, 75% and 87,5%, respectively. It can be seen that pattern 2 of FIG. 5a and pattern 2 of FIG. 5b have the same density, but the patterns are different in which subframes (in time) are specified as being ABS subframes. This equally applies to pattern no. 3-7 of FIG. 5a and FIG. 5b, respectively.

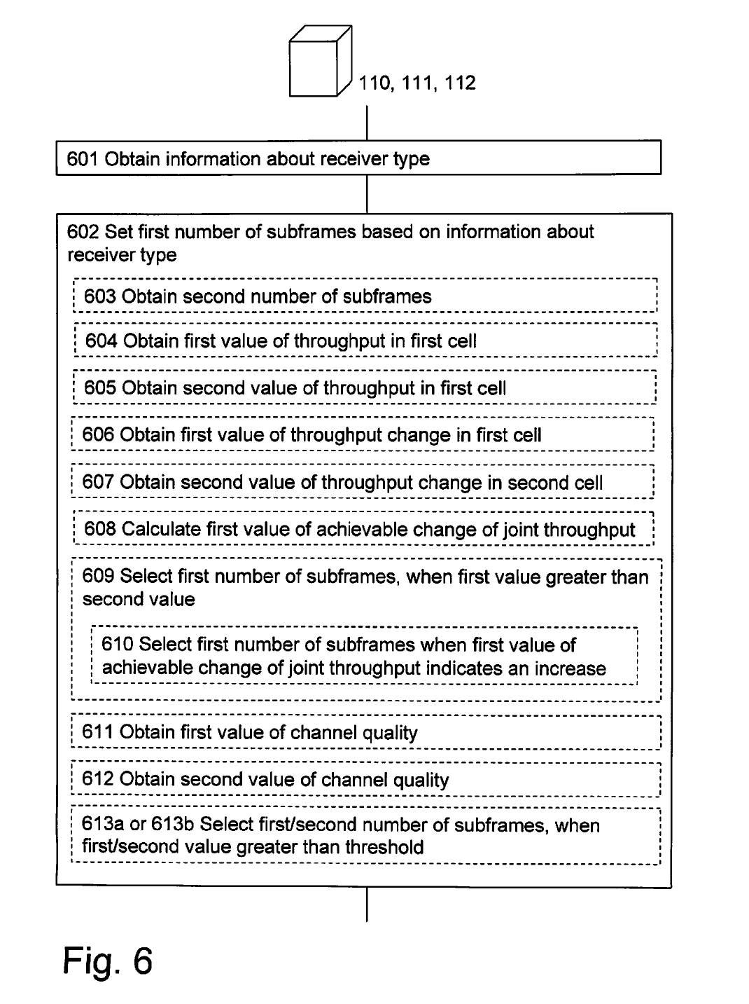

In FIG. 6, an exemplifying, schematic flowchart of the methods of FIG. 2 when seen from the network node 110, 111, 112 is shown. As mentioned, the network node 110, 111, 112 performs a method for setting a first number of subframes for downlink transmission of a first cell 121. The downlink transmission in each subframe of the first number of subframes has a reduced power. The at least one first user equipment 131 may be in a cell range expansion area of the second cell 122.

The following actions may be performed in any suitable order.

### Action 601

The network node 110, 111, 112 obtains information about at least one first user equipment's 131 capability of mitigating interference, the interference being caused by the downlink transmission.

As a first example, when the second radio network node 112 operates the second cell 122, the network node 110, 111, 112 may receive 201b the information from the second radio network node 112. In this example, the network node 110, 111, 112 may be a central node 1110 or a macro node 111.

As a second example, the network node 110, 111, 112 may estimate the information about at least one first user equipment's 131 capability of mitigating interference, or may receive, from the at least one first user equipment 131, the information about at least one first user equipment's 131 capability of mitigating interference. This action is similar to actions 201a and/or 201b.

### Action 602

The network node 110, 111, 112 sets the first number of subframes based on the information about the at least one first user equipment's 131 capability of mitigating the interference.

In some scenarios, ABS/RPSF may be completely turned off if the UE has a IC capable receiver. Therefore, the setting of action 602 may comprise setting the first number of subframes to zero.

The setting of the first number of subframes may further be based on one or more of:

a number of user equipments, in the second cell 122, with capability of mitigating the interference;

a bit rate relating to the at least one first user equipment 131 in a cell range expansion area of the second cell 122; and a load relating to user equipments, in the second cell 122, with capability of mitigating the interference.

This action is similar to action 202.

### Action 603

The setting of action 602 may further comprise obtaining a second number of subframes for downlink transmission of the first cell 121.

The second number of subframes may be different from the first number of subframes. This action is similar to action 203.

### Action 604

The setting 202 may further comprise obtaining a first value of throughput, achievable in the first cell 121 for the first number of subframes. This action is similar to action 204.

### Action 605

The network node 110, 111, 112 may obtain a second value of throughput, achievable in the first cell 121 for the second number of subframes. This action is similar to action 205.

### Action 606

The setting of action 602 may further comprise obtaining a first value of throughput change, achievable in the first cell 121, based on a first difference between the first value of throughput and the second value of throughput. This action is similar to action 206.

### Action 607

The network node 110, 111, 112 may obtain a second value of throughput change, achievable in the second cell 122, based on a second difference between a third value of throughput, achievable in the second cell 122 for the first number of subframes, and a fourth value of throughput, achievable in the second cell 122 for the second number of subframes. This action is similar to action 207.

### Action 608

The network node 110, 111, 112 may calculate a first value indicating achievable change of joint throughput in the first and second cells 121, 122, wherein the first value indicating achievable change of joint throughput is calculated as a third difference between the first value of throughput change and the second value of throughput change. This action is similar to action 208.

### Action 609

Preferably after actions 204 and 205, the network node 110, 111, 112 may select the first number of subframes, when the first value of throughput is greater than the second value of throughput. This action is similar to action 209.

### Action 610

Preferably after actions 206, 207 and 208 have been performed, the selecting of action 609 may further comprise selecting the first number of subframes, when the first value indicating achievable change of joint throughput indicates an increase of the joint throughput in the first and second cells 121, 122. This action is similar to action 210.

### Action 611

The setting of action 602 may further comprise obtaining a first value of channel quality for the at least one first user equipment 131 while taking the information about the at least one first user equipment's 131 capability of mitigating the interference and the first number of subframes into account. This action is similar to action 211.

### Action 612

The network node 110, 111, 112 may obtain a second value of channel quality for the at least one first user equipment 131 while taking the information about the at least one first user equipment's 131 capability of mitigating the interference and the second number of subframes into account. This action is similar to action 212.

Following actions 611 and 612, action 613a or 613b may be performed.

### Action 613a

The network node 110, 111, 112 may select the first number of subframes, when the first value of channel quality is greater than a threshold for required channel quality at the at least one first user equipment 131. This action is similar to action 213a.

### Action 613b

The network node 110, 111, 112 may select the second number of subframes, when the second value of channel quality is greater than a threshold for required channel quality at the at least one first user equipment 131. This action is similar to action 213b.

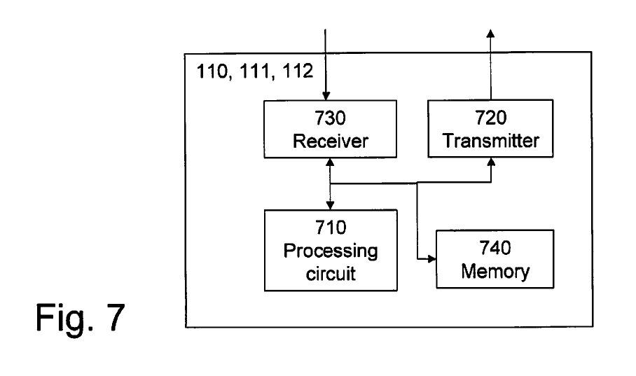

With reference to FIG. 7, a schematic block diagram of the network node 110, 111, 112 is shown. The network node 110, 111, 112 is configured to perform the methods in FIG. 2, 3, 4 and/or 6. The network node 110, 111, 112 is configured to set a first number of subframes for downlink transmission of a first cell 121. As mentioned, the downlink transmission in each subframe of the first number of subframes has a reduced power. As mentioned, the at least one first user equipment 131 may be in a cell range expansion area of the second cell 122.

The network node 110, 111, 112 comprises a processing circuit 710 configured to: obtain information about at least one first user equipment's 131 capability of mitigating interference, the interference being caused by the downlink transmission. Furthermore, the processing circuit 719 is configured to set the first number of subframes based on the information about the at least one first user equipment's 131 capability of mitigating the interference.

The processing circuit 710 may further be configured to set the first number of subframes is based on one or more of:

a number of user equipments, in the second cell 122, with capability of mitigating the interference;

a bit rate relating to the at least one first user equipment 131 in a cell range expansion area of the second cell 122; and a load relating to user equipments, in the second cell 122, with capability of mitigating the interference.

The processing circuit 710 may further be configured to obtain a second number of subframes for downlink transmission of the first cell 121. The second number of subframes may be different from the first number of subframes.

The processing circuit 710 may further be configured to: obtain a first value of throughput, achievable in the first cell 121 for the first number of subframes; obtain a second value of throughput, achievable in the first cell 121 for the second number of subframes; and select the first number of subframes, when the first value of throughput is greater than the second value of throughput.

The processing circuit 710 may further be configured to: obtain a first value of throughput change, achievable in the first cell 121, based on a first difference between the first value of throughput and the second value of throughput; obtain a second value of throughput change, achievable in the second cell 122, based on a second difference between a third value of throughput, achievable in the second cell 122 for the first number of subframes, and a fourth value of throughput, achievable in the second cell 122 for the second number of subframes; and calculate a first value indicating achievable change of joint throughput in the first and second cells 121, 122, wherein the first value indicating achievable change of joint throughput is calculated as a third difference between the first value of throughput change and the second value of throughput change; select the first number of subframes, when the first value indicating achievable change of joint throughput indicates an increase of the joint throughput in the first and second cells 121, 122.

The processing circuit 710 may further be configured to: obtain a first value of channel quality for the at least one first user equipment 131 while taking the information about the at least one first user equipment's 131 capability of mitigating the interference and the first number of subframes into account; and obtain a second value of channel quality for the at least one first user equipment 131 while taking the information about the at least one first user equipment's 131 capability of mitigating the interference and the second number of subframes into account; select the first number of subframes, when the first value of channel quality is greater than a threshold for required channel quality at the at least one first user equipment 131, or select the second number of subframes, when the second value of channel quality is greater than a threshold for required channel quality at the at least one first user equipment 131.

The processing circuit 710 may further be configured to set the first number of subframes to zero.

The processing circuit 710 may further be configured to receive the information from the second radio network node 112.

The processing circuit 710 may further be configured to estimate the information, or receive the information from the at least one first user equipment 131.

The processing circuit 710 may be a processing unit, a processor, an application specific integrated circuit (ASIC), a field-programmable gate array (FPGA) or the like. As an example, a processor, an ASIC, an FPGA or the like may comprise one or more processor kernels.

The network node 110, 111, 112 further comprises a transmitter 720, which may be configured to send one or more of the information about at least one first user equipment's 131 capability of mitigating interference, the first value of throughput, the second value of throughput, the first value of throughput change, the second value of throughput change, the first value indicating achievable change of joint throughput and other numbers, values or parameters described herein.

The network node 110, 111, 112 further comprises a receiver 730, which may be configured to receive one or more of the information about at least one first user equipment's 131 capability of mitigating interference, the first value of throughput, the second value of throughput, the first value of throughput change, the second value of throughput change, the first value indicating achievable change of joint throughput and other numbers, values or parameters described herein.

The network node 110, 111, 112 further comprises a memory 740 for storing software to be executed by, for example, the processing circuit. The software may comprise instructions to enable the processing circuit to perform the method in the network node 110, 111, 112 as described above in conjunction with FIG. 2, 3, 4 and/or 6. The memory 740 may be a hard disk, a magnetic storage medium, a portable computer diskette or disc, flash memory, random access memory (RAM) or the like. Furthermore, the memory may be an internal register memory of a processor.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

Even though embodiments of the various aspects have been described, many different alterations, modifications and the like thereof will become apparent for those skilled in the art. The described embodiments are therefore not intended to limit the scope of the present disclosure.

1. A method in a network node for setting a first number of subframes for downlink transmission of a first cell, wherein the downlink transmission in each subframe of the first number of subframes has a reduced power, wherein the method comprises:
obtaining information about at least one first user equipment's capability of mitigating interference, the interference being caused by the downlink transmission; and
setting the first number of subframes based on the information about the at least one first user equipment's capability of mitigating the interference.

2. The method according to claim 1, wherein the setting of the first number of subframes further is based on one or more of:
a number of user equipments, in the second cell, with capability of mitigating the interference;
a bit rate relating to the at least one first user equipment in a cell range expansion area of the second cell; and
a load relating to user equipments, in the second cell, with capability of mitigating the interference.

3. The method according to claim 1, wherein the setting further comprises:
obtaining a second number of subframes for downlink transmission of the first cell.

4. The method according to claim 3, wherein the setting further comprises:
obtaining a first value of throughput, achievable in the first cell for the first number of subframes;
obtaining a second value of throughput, achievable in the first cell for the second number of subframes; and
selecting the first number of subframes, when the first value of throughput is greater than the second value of throughput.

5. The method according to claim 4, wherein the setting further comprises:
obtaining a first value of throughput change, achievable in the first cell, based on a first difference between the first value of throughput and the second value of throughput;
obtaining a second value of throughput change, achievable in the second cell, based on a second difference between a third value of throughput, achievable in the second cell for the first number of subframes, and a fourth value of throughput, achievable in the second cell for the second number of subframes; and
calculating a first value indicating achievable change of joint throughput in the first and second cells, wherein the first value indicating achievable change of joint throughput is calculated as a third difference between the first value of throughput change and the second value of throughput change;
wherein selecting further comprises:
selecting the first number of subframes, when the first value indicating achievable change of joint throughput indicates an increase of the joint throughput in the first and second cells.

6. The method according to claim 4, wherein the second number of subframes is different from the first number of subframes.

7. The method according to claim 3, wherein the setting further comprises:
obtaining a first value of channel quality for the at least one first user equipment while taking the information about the at least one first user equipment's capability of mitigating the interference and the first number of subframes into account; and
obtaining a second value of channel quality for the at least one first user equipment while taking the information about the at least one first user equipment's capability of mitigating the interference and the second number of subframes into account;
selecting the first number of subframes, when the first value of channel quality is greater than a threshold for required channel quality at the at least one first user equipment, or
selecting the second number of subframes, when the second value of channel quality is greater than a threshold for required channel quality at the at least one first user equipment.

8. The method according to claim 1, wherein the setting of the first number of subframes comprises setting the first number of subframes to zero.

9. The method according to claim 1, wherein the at least one first user equipment is in a cell range expansion area of the second cell.

10. The method according to claim 1, wherein a second radio network node operates the second cell, wherein the obtaining of information about the at least one first user equipment's capability of mitigating the interference comprises:
receiving the information from the second radio network node.

11. The method according to claim 1, wherein the obtaining of information about the at least one first user equipment's capability of mitigating the interference comprises:
estimating the information, or
receiving the information from the at least one first user equipment.

12. A network node configured to set a first number of subframes for downlink transmission of a first cell, wherein the downlink transmission in each subframe of the first number of subframes has a reduced power, wherein the network node comprises:
a processing circuit configured to:
obtain information about at least one first user equipment's capability of mitigating interference, the interference being caused by the downlink transmission; and
set the first number of subframes based on the information about the at least one first user equipment's capability of mitigating the interference.

13. The network node according to claim 12, wherein the processing circuit further is configured to set the first number of subframes is based on one or more of:
a number of user equipments, in the second cell, with capability of mitigating the interference;
a bit rate relating to the at least one first user equipment in a cell range expansion area of the second cell; and
a load relating to user equipments, in the second cell, with capability of mitigating the interference.

14. The network node according to claim 11, wherein the processing circuit is configured to:
obtain a second number of subframes for downlink transmission of the first cell.

15. The network node according to claim 14, wherein the processing circuit is configured to:
obtain a first value of throughput, achievable in the first cell for the first number of subframes;
obtain a second value of throughput, achievable in the first cell for the second number of subframes; and
select the first number of subframes, when the first value of throughput is greater than the second value of throughput.

16. The network node according to claim 15, wherein the processing circuit is configured to:
obtain a first value of throughput change, achievable in the first cell, based on a first difference between the first value of throughput and the second value of throughput;
obtain a second value of throughput change, achievable in the second cell, based on a second difference between a third value of throughput, achievable in the second cell for the first number of subframes, and a fourth value of throughput, achievable in the second cell for the second number of subframes; and
calculate a first value indicating achievable change of joint throughput in the first and second cells, wherein the first value indicating achievable change of joint throughput is calculated as a third difference between the first value of throughput change and the second value of throughput change;
select the first number of subframes, when the first value indicating achievable change of joint throughput indicates an increase of the joint throughput in the first and second cells.

17. The network node according to claim 15, wherein the second number of subframes is different from the first number of subframes.

18. The network node according to claim 12, wherein the processing circuit is configured to:
obtain a first value of channel quality for the at least one first user equipment while taking the information about the at least one first user equipment's capability of mitigating the interference and the first number of subframes into account; and
obtain a second value of channel quality for the at least one first user equipment while taking the information about the at least one first user equipment's capability of mitigating the interference and the second number of subframes into account;
select the first number of subframes, when the first value of channel quality is greater than a threshold for required channel quality at the at least one first user equipment, or select the second number of subframes, when the second value of channel quality is greater than a threshold for required channel quality at the at least one first user equipment.

19. The network node according to claim 12, wherein the processing circuit is configured to:
set the first number of subframes to zero.

20. The network node according to claim 12, wherein the at least one first user equipment is in a cell range expansion area of the second cell.

21. The network node according to claim 12, wherein a second radio network node operates the second cell, wherein the processing circuit is configured to:
receive the information from the second radio network node.

22. The network node according to claim 12, wherein the processing circuit is configured to:
estimate the information, or receive the information from the at least one first user equipment.
